(19) United States
(12) Patent Application Publication
(10) Pub. No.: US 2004/0090554 A1
(43) Pub. Date: May 13, 2004

(54) Picture coding method

(76) Inventor: Takahiro Nishi, Katano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/688,880

(22) Filed: Oct. 21, 2003

(30) Foreign Application Priority Data
Oct. 23, 2002 (JP) 2002-308225

(51) Int. Cl. H04N 7/12

(52) U.S. Cl. 348/441; 375/240.01

(57) ABSTRACT

A picture coding apparatus is comprised of: (i) a sampling converter 102a that converts a progressive picture signal 101 inputted at a first sampling rate into a progressive picture signal 103 to be sampled at a second sampling rate according to a frame repetition signal in telecine conversion information 106 when such telecine conversion information 106 indicates a telecine picture, while converting the progressive picture signal 101 inputted at the first sampling rate into the progressive picture signal 103 to be sampled at a third sampling rate when the telecine conversion information 106 indicates a non-telecine picture; and (ii) a picture encoder 104 that codes the progressive picture signal 103 for which sampling conversion has been performed and outputs the resulting signal as coded picture data 105.

### BACKGROUND OF THE INVENTION

(1) Field of the Invention

The present invention relates to a picture coding method for coding a progressive picture, and particularly to a picture coding method for coding a progressive picture signal including at least either a part which was originally a cinema signal or a part which was originally an NTSC signal.

(2) Description of the Related Art

In the age of multimedia which integrally handles audio, video and other information such as pixel values, existing information media, i.e. newspaper, magazine, television, radio, telephone and other means through which information is conveyed to people, have recently come to be included in the scope of multimedia. Generally, multimedia refers to representing information by associating not only characters, but also graphics, voices, and especially pictures and the like together. However, in order to include the aforementioned existing information media in the scope of multimedia, it appears as a prerequisite to represent such information in digital form.

However, when calculating the amount of information contained in each of the aforementioned information media as the amount of digital information, while the amount of information per character is 1˜2 bytes in the case of characters, the amount of information to be required is 64 Kbits or over per second in the case of voices (telephone quality), and 100 Mbits or over per second in the case of moving pictures (current television reception quality), and it is not realistic for the aforementioned information media to handle such an enormous amount of information as it is in digital form. For example, although video phones are already in the actual use by using Integrated Services Digital Network (ISDN) which offers a transmission speed of 64 Kbit/s˜1.5 Mbits/s, it is not possible to transmit video information taken by a television camera directly through ISDN.

Against this backdrop, information compression techniques have become required, and moving picture compression techniques compliant with H.261 and H.263 internationally standardized by ITU-T (International Telecommunication Union-Telecommunication Standardization Sector) are employed for video phones, for example. Moreover, according to the information compression technique compliant with the MPEG-1 standard, it is possible to store video information in an ordinary music CD (compact disc) together with audio information.

Here, MPEG (Moving Picture Experts Group) is an international standard on compression of moving picture signals, and MPEG-1 is a standard for compressing television signal information approximately into one hundredth so that moving picture signals can be transmitted at a rate of 1.5 Mbps. Furthermore, since a transmission speed within the scope of the MPEG-1 standard is limited primarily to about 1.5 Mbps, MPEG-2, which was standardized with a view to satisfying requirements for further improved picture quality, allows moving picture signals to be transmitted at a rate of 2˜15 Mbps. Moreover, MPEG-4 was standardized by the working group (ISO/IEC JTC1/SC29/WG11) which was engaged in the standardization of MPEG-1 and MPEG-2. MPEG-4 provides a higher compression ratio than that of MPEG-1 and MPEG-2 and allows object-based coding, decoding and manipulation of picture data, which are new functionalities required in this age of multimedia. At first, an effort was being made to establish a standard on a method of coding picture data at a row bit rate, but the scope of MPEG-4 has been extended as a more general coding standard that handles interlaced pictures as well as coding at a high bit rate.

Presently, preparations are under way for a terrestrial digital television broadcasting as a service that utilizes a moving picture compression technique. This service is planned to provide not only a high-quality broadcasting service to fixed receiving terminals (e.g. televisions at home) but also a simplified video broadcasting service to mobile receiving terminals. In the operation guidelines on broadcasting intended for mobile receiving terminals, it is defined that QVGA-sized (240 by 320 pixels) progressive pictures shall be coded and broadcasted at a sampling rate of 15 frames/s or below.

Possible services handling the coding and transmission of progressive pictures include moving picture streaming and moving picture downloading by the use of the Internet.

In order to reuse television content broadcasted in the past and broadcast content for fixed receiving terminals in the above services for performing coding on progressive pictures, it is necessary to generate a progressive picture signal from an interlaced picture signal such as an NTSC signal. FIG. 1 shows an example of converting an NTSC signal into a progressive picture signal. Circled numbers in FIG. 1 indicate frame numbers of frames in an NTSC signal which are original pictures. In an NTSC signal, it is possible to convert field images into progressive pictures to be outputted at a rate of 30 frames/s, by converting, for example, the size of either of the two fields in each frame.

FIG. 2 is a block diagram showing an example of an existing picture coding apparatus for coding progressive pictures. In the case of reusing the content of an interlaced picture signal, such interlaced picture signal is converted, in advance, into progressive pictures outside the picture coding apparatus, and then inputted to the picture coding apparatus as a progressive picture signal 101. The existing picture coding apparatus shown in FIG. 2 is comprised of: (i) a sampling converter 102a that converts the progressive picture signal 101 inputted at a first predetermined sampling rate (e.g. 30 frames/s) into a progressive picture signal 801 to be sampled at a second predetermined sampling rate (e.g. 15 frames/s) by re-sampling such progressive picture signal 101 at a constant interval; and (ii) a picture encoder 104 that codes the progressive picture signal 801 to be sampled at the second predetermined sampling rate so as to output coded picture data. In this existing picture coding apparatus, the sampling converter 102a samples the progressive picture signal 101 at constant frame intervals so as to convert it into the progressive picture signal 801 to be sampled at the second predetermined sampling rate, and the picture encoder 104 codes such progressive picture signal 801 for which sampling conversion has been performed, and outputs the resulting signal as coded picture data 802.

However, some television content in the past and broadcast content for fixed receiving terminals include a mixture of a part which was originally an NTSC signal, i.e. a part which was generated originally as an NTSC signal to be outputted at a rate of 30 frames/s (to be referred to as “non-telecine picture” hereinafter) and a part which was originally a cinema signal, i.e. a part which was generated originally as a cinema signal to be outputted at a rate of 24 frames/s (to be referred to as “telecine picture” hereinafter).

In order to be broadcasted as television content, a telecine picture part is converted from a cinema signal to be outputted at a rate of 24 frames/s into an NTSC signal to be outputted at a rate of 30 frames/s (to be referred to as “telecine conversion” hereinafter). FIG. 3 illustrates an example of converting a cinema signal into a telecine picture signal (interlace) and the telecine picture signal into a progressive picture signal. Circled numbers in FIG. 3 indicate the frame numbers of frames in a cinema signal which are original pictures. Through telecine conversion, telecine pictures as shown in FIG. 3 are generated from the original cinema signal by repeatedly converting fields corresponding to frames in such original cinema signal in a rhythm of “3, 2, 3, and 2”. When one of the two fields (e.g. top field) in each of frames in such telecine picture signal is converted into a progressive picture, frames with the same content are generated cyclically as shown in FIG. 3. When progressive pictures generated in the above manner are reproduced at a rate of 30 frames/s, there occurs a strong fluctuation in the frame display speed from a visual standpoint, as compared to that of the telecine pictures, which results in unnatural motions. Moreover, when the above progressive pictures are sampled every two frames and the resultant is reproduced at a rate of 15 frames/s, there occurs a far stronger fluctuation in the frame display speed from a visual standpoint, resulting in increasingly unnatural motions in coded picture data.

Therefore, when the existing picture coding apparatus shown in FIG. 2 performs coding on such progressive picture signal, coded picture data with unnatural motions is generated.

Meanwhile, there is another existing picture coding apparatus that receives interlaced picture data including a mixture of telecine pictures and non-telecine pictures and performs inverse-telecine conversion on the telecine picture part, so as to code it as an interlaced picture signal, utilizing flags indicating a repetition of fields (Refer to Japanese Laid-Open Patent application No. 11-252513 (pp. 5˜19, FIG. 2)).

However, since such existing coding method is intended for coding an input picture signal as an interlaced picture signal, meaning that there is a problem that this method is not applicable to the coding of a progressive picture signal.

Furthermore, since the existing picture coding apparatus shown in FIG. 2 performs coding always at the same sampling rate, unnatural motions are generated as a result of performing coding, as a progressive picture signal, on an input picture signal that constitutes a mixture of a part which was originally a cinema signal and a part which was originally an NTSC signal.

### SUMMARY OF THE INVENTION

The present invention has been conceived in view of the above problems, and it is an object of the present invention to provide a picture coding method in which an input picture signal including a mixture of a part which was originally a cinema signal and a part which was originally an NTSC signal is efficiently coded as a progressive picture in a manner in which unnatural motions are eliminated or minimized.

In order to achieve the above object, the picture coding method according to the present invention is a picture coding method for coding a progressive picture signal including at least either a cinema signal part which was originally a cinema signal or an NTSC signal part which was originally an NTSC signal for television broadcasting, the picture coding method comprising: a sampling step of sampling frames from frames in the cinema signal part in the progressive picture signal using a first method and frames from frames in the NTSC signal part in the progressive picture signal using a second method; and a coding step of coding the frames which are sampled in the sampling step.

Accordingly, since a progressive picture signal including a mixture of a part which was originally a cinema signal and a part which was originally an NTSC signal can be coded after being sampled in a sampling method (e.g. sampling rate or a sampling rhythm) appropriate for the respective parts, it becomes possible to eliminate or minimize unnatural motions.

In the above picture coding method, the cinema signal part in the progressive picture signal is a signal that includes two identical consecutive frames for every predetermined number of frames, the signal being a progressive picture signal converted from an NTSC signal which has been converted from the cinema signal, and in the first method, one of said two frames is eliminated, and the sampling is performed at equal intervals.

Note that “identical frames” refers to frames generated from a single original picture.

Moreover, in the picture coding method, the sampling is performed at equal intervals in which the number of frames per second is a divisor of 24 in the first method.

Accordingly, when a progressive picture signal including a mixture of a part which was originally a cinema signal and a part which was originally an NTSC signal is coded, since the part which was originally a cinema signal can be coded by the use of a divisor of a sampling rate for a cinema signal, it is possible to eliminate a fluctuation in the display speed from a visual standpoint and to eliminate or minimize unnatural motions.

Also, in the picture coding method, the cinema signal part in the progressive picture signal is a signal that includes two identical consecutive frames for every predetermined number of frames, the signal being a progressive picture signal converted from an NTSC signal which has been converted from the cinema signal, and in the first method, the sampling is performed in a manner in which frame intervals become predetermined unequal intervals with respect to said two identical consecutive frames.

Accordingly, when a progressive picture signal including a mixture of a part which was originally a cinema signal and a part which was originally an NTSC signal is coded, unnatural motions are eliminated or minimized, since it is possible to eliminate a fluctuation in the display speed from a visual standpoint in a part which was originally a cinema signal. What is more, simple sampling processing can eliminate or minimize unnatural motions.

Furthermore, the picture coding method may further comprise an original picture judgment step of judging whether each frame in the progressive picture signal was originally a cinema signal or an NTSC signal, based on said progressive picture signal.

Accordingly, when a progressive picture signal including a mixture of a part which was originally a cinema signal and a part which was originally an NTSC signal is coded, since it is possible to detect, from an input progressive picture signal, telecine conversion information indicating whether such progressive picture signal was originally a cinema signal or an NTSC signal, there is no need for a user to prepare telecine conversion information. This consequently reduces the amount of work such user needs to do.

Note that the present invention can be realized not only as a picture coding method, but also as a picture coding apparatus that includes, as its units, the characteristic steps included in the above picture coding method, and as a program that causes a computer to execute such steps, as well as coded picture data which is generated using the above picture coding method. And it should be noted that such program and coded picture data can be distributed via recording media including CD-ROM and the like, and transmission media including the Internet and the like.

According to the picture coding method according to the present invention, it is possible to eliminate or minimize unnatural motions, since a progressive picture signal including a mixture of a part which was originally a cinema signal and a part which was originally an NTSC signal can be coded after being sampled in a sampling method appropriate for the respective parts.

Accordingly, the present invention makes it possible to code a progressive picture signal including a mixture of a part which was originally a cinema signal and a part which was originally an NTSC signal, with unnatural motions being eliminated or minimized. Therefore, the present invention is highly valuable from a practical point of view in the present age when coding is increasingly required to be performed on a progressive picture signal including a mixture of a part which was originally a cinema signal and a part which was originally an NTSC signal.

For further information about the technical background to this application, Japanese Patent application No. 2002-308225 filed on Oct. 23, 2002 is incorporated herein by reference.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a diagram explaining processing for converting a non-telecine picture signal into a progressive picture signal.

FIG. 2 is a block diagram showing a configuration of an existing picture coding apparatus.

FIG. 3 is a diagram explaining processing for converting a telecine picture signal into a progressive picture signal.

FIG. 4 is a block diagram showing a configuration of a picture coding apparatus according to a first embodiment of the present invention.

FIG. 5 is a block diagram showing a sampling converter according to the first embodiment of the present invention.

FIG. 6 is a diagram explaining sampling conversion according to the first embodiment of the present invention.

FIG. 7 is a diagram showing a schematic structure of a bit stream generated by performing coding according to MPEG-4.

FIG. 8 is a block diagram showing a sampling converter according to a second embodiment of the preset invention.

FIG. 9 is a diagram showing an example of sampling conversion according to the second embodiment of the present invention.

FIG. 10 is a diagram explaining another sampling conversion according to the second embodiment of the present invention.

FIG. 11 is a diagram explaining another sampling conversion according to the second embodiment of the present invention.

FIG. 12 is a block diagram showing a picture coding apparatus according to a third embodiment of the present invention.

FIG. 13 is a block diagram showing the picture coding apparatus according to the third embodiment of the present invention.

FIG. 14 is a flowchart showing an operation of a telecine picture judgment unit according to the third embodiment of the present invention.

FIG. 15 is a diagram explaining a recording medium that stores a program for realizing the picture coding method presented in each of the embodiments of the present invention in a computer system, wherein

FIG. 15A illustrates an example physical format of a flexible disk as a recording medium itself,

FIG. 15B shows an external view of the flexible disk viewed from the front, a schematic cross-sectional view and the flexible disk, and

FIG. 15C shows a structure for recording and reading out the program on and from the flexible disk.

FIG. 16 is a block diagram showing an overall structure of a content supply system for realizing a content distribution service.

FIG. 17 is a diagram showing an example of a cellular phone.

FIG. 18 is a block diagram showing an internal configuration of the cellular phone.

FIG. 19 is a block diagram showing an overall structure of a digital broadcasting system.

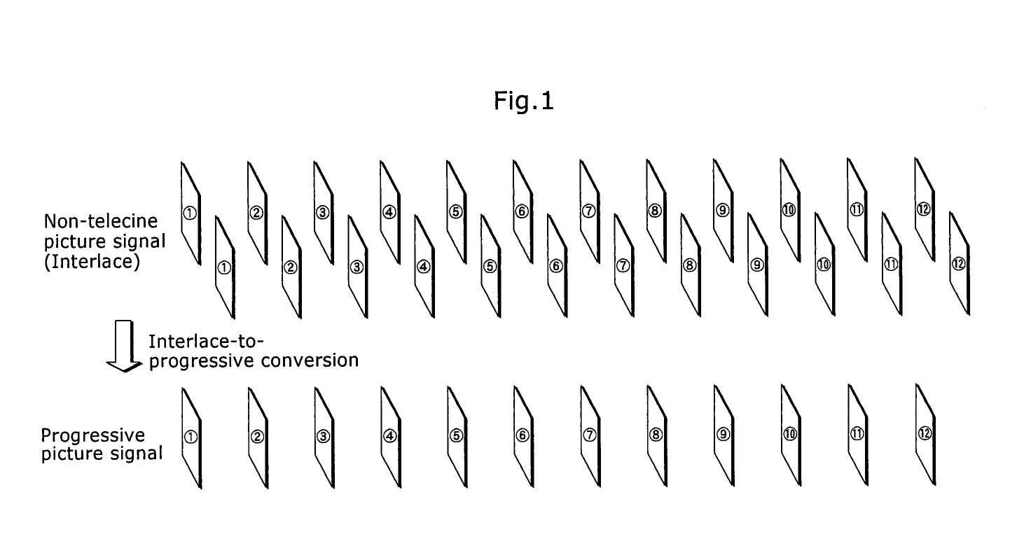

### DESCRIPTION OF THE PREFERRED EMBODIMENTS

An explanation is given of the preferred embodiments of the present invention with reference to the figures.

(First Embodiment)

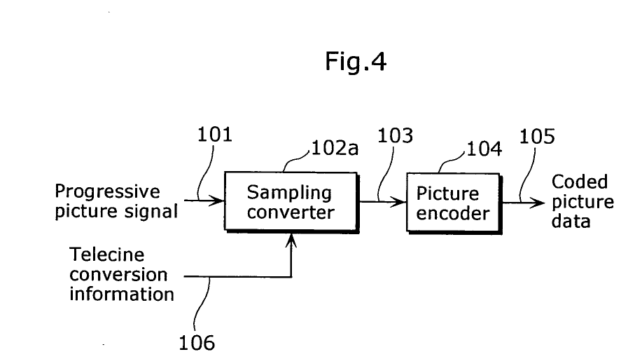

Referring to FIGS. 4˜7, the first embodiment of the present invention is explained.

FIG. 4 is a block diagram showing the configuration of a picture coding apparatus according to the first embodiment of the present invention.

The picture coding apparatus according to the first embodiment is capable of switching a sampling method (e.g. sampling rate or a sampling rhythm) employed for a current frame to be coded to another one, according to a signal inputted from outside and capable of performing coding on a progressive picture signal including a mixture of a part which was originally a cinema signal and a part which was originally an NTSC signal by the use of a sampling method appropriate to the respective parts.

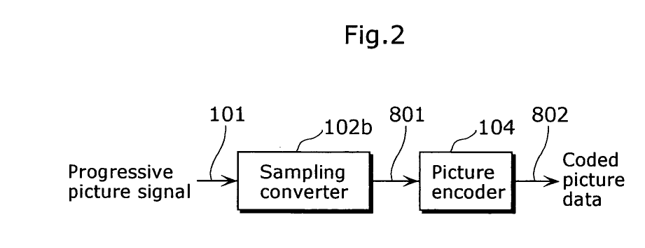

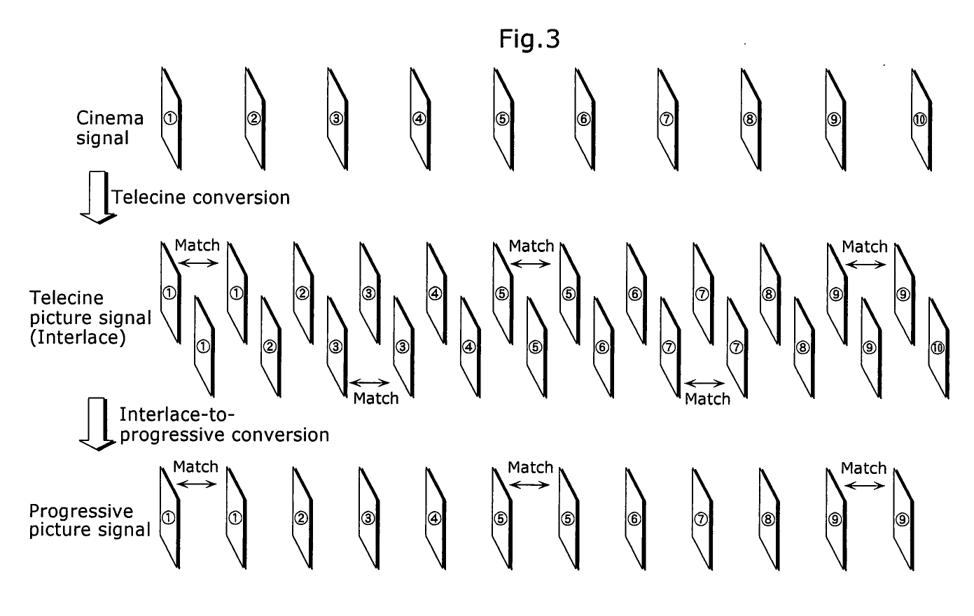

The picture coding apparatus according to the present embodiment is different from the existing picture coding apparatus shown in FIG. 2 in that the sampling converter 102a converts sampling for the progressive picture signal 101 depending on telecine conversion information 106. The telecine conversion information 106, which is inputted from outside the picture coding apparatus according to the present embodiment, indicates telecine conversion-related information about original pictures corresponding to the respective frames in the progressive picture signal 101. More specifically, the telecine conversion information 106 includes (i) telecine identification information indicating whether each of original pictures of the respective frames in the progressive picture signal 101 is a cinema signal or an NTSC signal and (ii) a frame repetition signal indicating whether there is a frame repeating itself or not. The other configuration and operations of the picture coding apparatus according to the present embodiment are the same as those of the existing picture coding apparatus shown in FIG. 2, and therefore an explanation is given here only of the sampling converter 102a.

When a telecine identification signal in the telecine conversion information 106 indicates a telecine picture, the sampling converter 102a converts the progressive picture signal 101 inputted at the first sampling rate (e.g. 30000/1001 frames/s) which is suited to display an NTSC signal as progressive pictures into the progressive picture signal 103 to be sampled at the second sampling rate (e.g. 24000/1001 frames/s) which is suited to display a cinema signal as progressive pictures, according to a frame repetition signal in the telecine conversion information 106. When a telecine identification signal in the telecine conversion information 106 indicates a non-telecine picture, the sampling converter 102a converts the progressive picture signal 101 inputted at the first sampling rate into the progressive picture signal 103 to be sampled at the third sampling rate (e.g. 30000/1001 frames/s) which is suited to display an NTSC signal as progressive pictures, and outputs such progressive picture signal 103 for which sampling conversion has been performed.

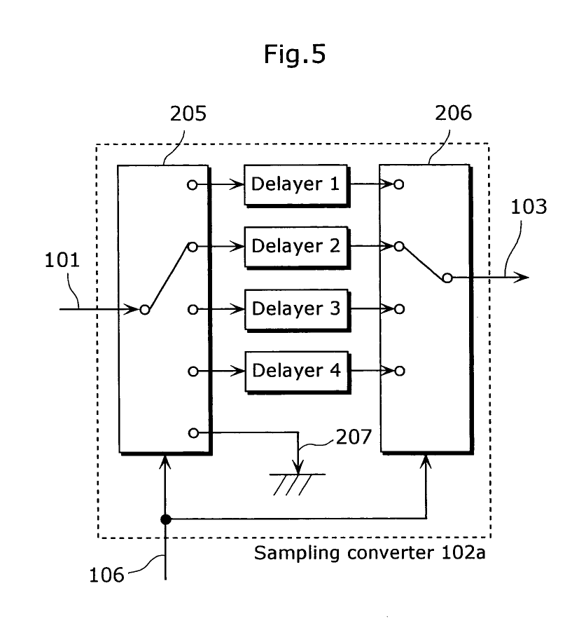

FIG. 5 is a diagram showing an example configuration of the sampling converter 102a according to the first embodiment.

In an example shown in FIG. 5, the sampling converter 102a includes a delayer 1˜a delayer 4 and switches 205 and 206. When a telecine identification signal in the telecine conversion information 106 indicates a telecine picture, the switch 205 selects the delayer 1 at the timing when a frame repetition signal in the telecine conversion information 106 indicates “repetition”. From then on, the switch 205 switches to a delayer on a frame-by-frame basis in order starting with the delayer 1, followed by the delayer 2, the delayer 3, the delayer 4 and a ground output 207, and outputs the inputted progressive picture signal 101 on a frame-by-frame basis. When this is done, the switch 206 selects the delayer 1 in synchronization with the switch 205 at the timing when a frame repetition signal in the telecine conversion information 106 indicates “repetition”. From then on, the switch 206 switches to a delayer in order starting with the delayer 1, followed by the delayer 2, the delayer 3, and the delayer 4, according to a timing when the switch 205 switches to a delayer, for every frame time interval after sampling conversion, and outputs the progressive picture signal 103 for which sampling conversion has been performed.

Meanwhile, when a telecine identification signal in the telecine conversion information 106 indicates a non-telecine picture, the switch 205 outputs the inputted progressive picture signal 101 to the delayer 101. When this is done, the switch 206 outputs such output from the delayer 1 as the progressive picture signal 103 for which sampling conversion has been performed. Note that when this is done, a delayer does not have to be the delayer 1 as long as the switch 205 and the switch 206 select the same delayer and continue to use it.

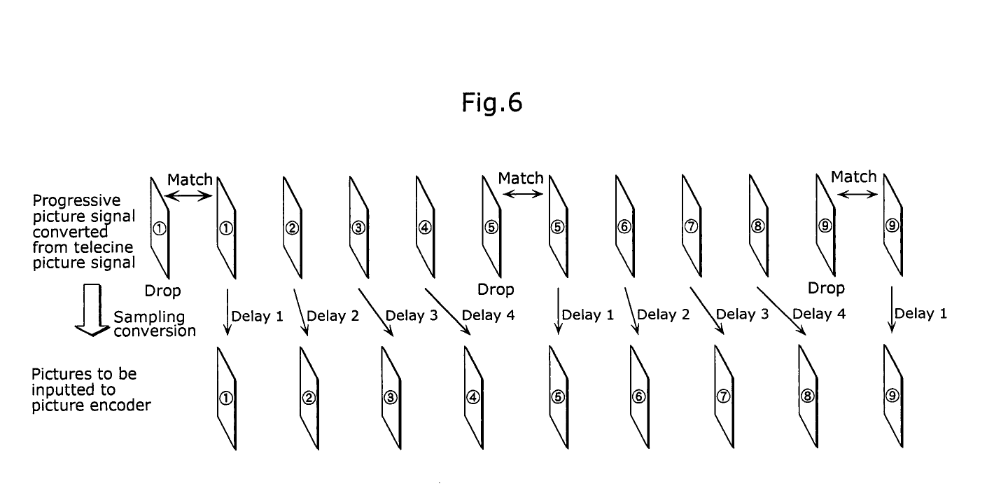

FIG. 6 is a diagram showing a concept of sampling conversion performed by the sampling converter 102a shown in FIG. 5, when an original picture is a telecine picture. In FIG. 6, delays 1˜4 indicate delays that have been generated by the respective delayers 1˜4. Letting that the delay 1 be Δt1 second and the amount Δtk of a delay k be Δtk=Δt1+(k−1)×(1/OFR−1/IFR), a time interval among each of frames for which sampling conversion has been performed will be constant. Here, “k” denotes an integer ranging from 1˜4, “OFR” denotes a sampling rate after sampling conversion (frame/second), “IFR” denotes a sampling rate before sampling conversion (frame/second).

Note that original pictures in an input progressive picture signal are not necessarily a mixture of a cinema signal and an NTSC signal, and therefore that an input picture signal may be a progressive picture signal converted from original pictures including only either of a cinema signal and an NTSC signal.

Also note that the above-described Δt1 may be 0 second.

Also, in the above explanation, the sampling converter 102a converts a sampling rate into either 24000/1001 frames/s or 30000/1001 frames/s depending on the telecine conversion information 106, but the sampling converter 102a does not necessarily have to convert a sampling rate into one of these sampling rates. Instead, the sampling converter 102a may thin out frames to reduce the amount of information contained in the coded picture data 105 and convert a sampling rate into either 24000/(1001×n) frames/s or 30000/(1001×n) frame/s (“n” is 2 or a larger integer).

Furthermore, the first to the third sampling rates are not limited to the above-given values, and therefore it is also possible to carry out the present embodiment with the first sampling rate being 30 frames/s, the second sampling rate being 24/m frame(s), and the third sampling rate being 30/m frame(s) (“m” is 1 or a larger integer), for example.

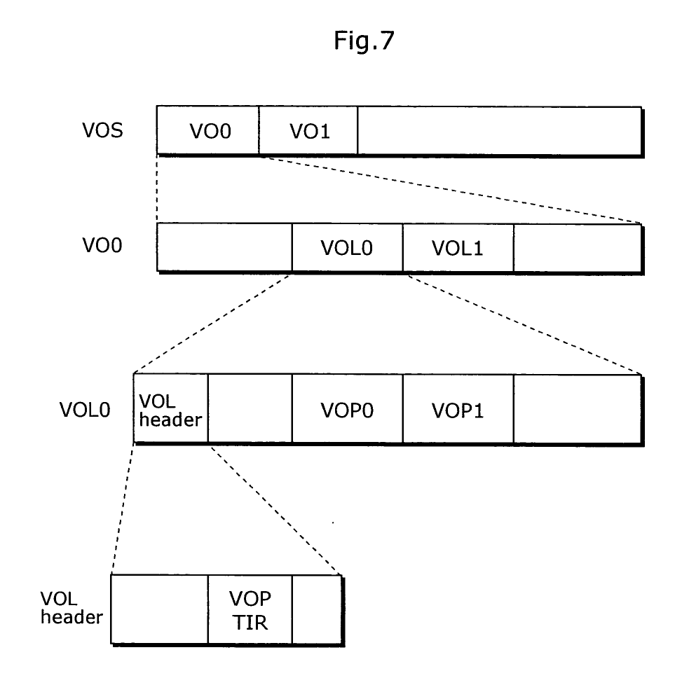

Also, in the first embodiment, a different sampling rate is used for the progressive picture signal 103 after sampling conversion outputted from the sampling converter 102a depending on whether a part in the input progressive picture signal 101 was originally a cinema signal or an NTSC signal, but this does not pose any significant problem. As shown in FIG. 7, when the picture encoder 104 performs coding according to MPEG-4, for example, on the progressive picture signal 103 for which frequency transform has been performed, information indicating a sampling rate is described in a VOP (Video Object Plane) time increment resolution (VOPTIR) within the VOL header included in a VOL (Visual Object Layer). Note that a VOL is included in a VO (Video Object) and a VO is included in a VOS (Visual Object Sequence) which is a sequence of the whole moving pictures.

As described above, it is possible for the picture coding apparatus according to the first embodiment to eliminate or minimize unnatural motions, since it is capable of converting a sampling rate into an optimum one according to the telecine conversion information 106 provided from outside, even when it codes a progressive picture signal including a mixture of a part which was originally a cinema signal and a part which was originally an NTSC signal. More specifically, the picture coding apparatus according to the first embodiment is capable of coding the part which was originally a cinema signal by the use of a divisor of the sampling rate for a cinema signal (more specifically 24000/(1001×n) frames/s or 24/m frame(s)/s (“n” and “m” are 1 or a larger integer)) and capable of coding the part which was originally an NTSC signal by the use of a sampling rate appropriate to display a non-telecine picture as a progressive picture (more specifically 30000/1001×n) frames/s or 30/m frame(s) (“n” and “m” are 1 or a larger integer)).

(Second Embodiment)

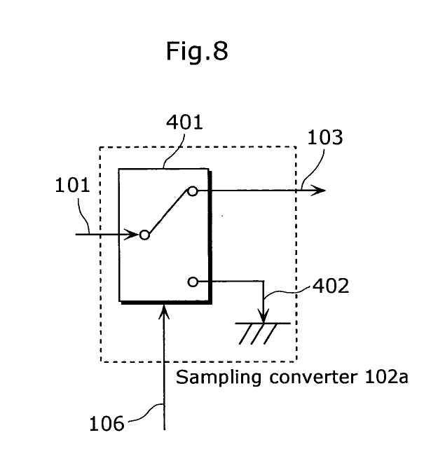

Referring to FIGS. 8˜11, the second embodiment according to the present invention is explained.

A picture coding apparatus according to the second embodiment is embodied by replacing the sampling converter in the picture coding apparatus according to the first embodiment of the present invention with a sampling converter that selectively samples frames, and is capable of performing coding on a progressive picture signal including a mixture of a part which was originally a cinema signal and a part which was originally an NTSC signal according to a sampling rhythm appropriate to the respective parts.

FIG. 8 is a diagram showing an example configuration of the sampling converter 102a according to the second embodiment. The picture coding apparatus according to the second embodiment is embodied by replacing the configuration of the sampling converter 102a according to the first embodiment of the present invention with the configuration illustrated in FIG. 8. The other configuration of the picture coding apparatus according to the present embodiment is the same as that of the first embodiment of the present invention, and therefore an explanation is given here only of the operation of the sampling converter 102a.

When a telecine identification signal in the telecine conversion information 106 indicates a telecine picture, the sampling converter 102a converts the progressive picture signal 101 inputted at the first sampling rate (e.g. 30000/1001 frames/s) which is suited to display an NTSC signal as progressive pictures into the progressive picture signal 103 to be sampled at the second sampling rate (e.g. 24000/2002 frames/s) according to a frame repetition signal in the telecine conversion information 106 by performing sampling in a first rhythm in which frame intervals are unequal and which is suited to display a cinema signal. When a telecine identification signal in the telecine conversion information 106 indicates a non-telecine picture, the sampling converter 102a converts the progressive picture signal 101 inputted at the first sampling rate into the progressive picture signal 103 to be sampled at the third sampling rate (e.g. 30000/2002 frames/s) by performing sampling in a second rhythm appropriate to display an NTSC signal as progressive pictures, and outputs the progressive picture signal 103 for which sampling conversion has been performed.

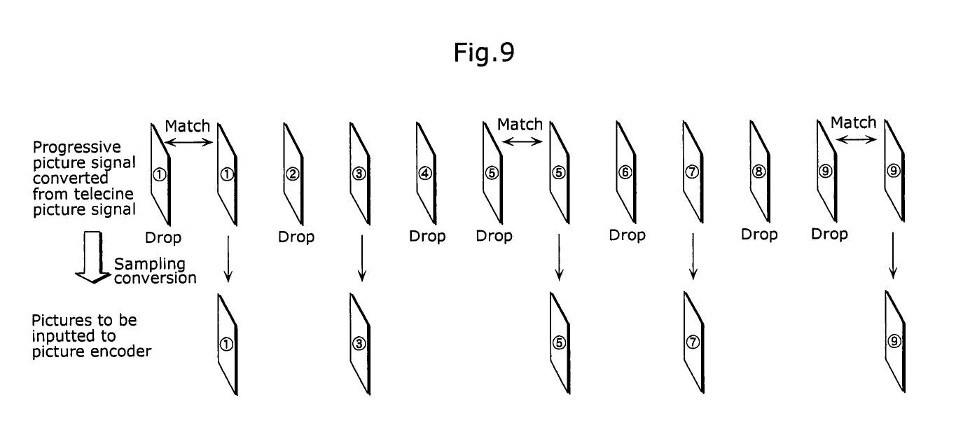

Referring to FIGS. 8 and 9, a concrete explanation is given of an example of the sampling converter 102a according to the second embodiment. FIG. 9 is a diagram showing a concept of sampling conversion performed by the sampling converter 102a illustrated in FIG. 8, when original pictures are telecine pictures.

In FIG. 8, when a telecine identification signal in the telecine conversion information 106 indicates a telecine picture, the switch 401 samples frames in the progressive picture signal 101 at every 2 frame intervals at the timing when a frame repetition signal in the telecine conversion information 106 indicates “repetition”, so as to output 1 frame in the input progressive picture signal 101 (in an example in FIG. 9, this frame is the latter of the two frames with the frame number 1 in display order) as a frame in the progressive picture signal 103 for which sampling conversion has been performed, and the next frame (the frame with the frame number 2) is directed to the ground output 402 and the next frame (the frame with the frame number 3) is outputted as a frame in the progressive picture signal 103. After this, the switch 401 samples frames in the progressive picture signal 101 in a rhythm of “3 frame intervals, 2 frame intervals, and 3 frame intervals” so as to output them as frames in the progressive picture signal 103 for which sampling conversion has been performed. Stated another way, as shown in FIG. 9, frames with the frame numbers 1, 3, 5, 7, and 9 are sampled to be outputted as the progressive picture signal 103 for which sampling conversion has been performed. By performing sampling in an uneven rhythm as described above, it is possible to minimize fluctuations in the frame update speed from a visual standpoint, as compared to the case where sampling is performed in an even rhythm.

Meanwhile, when a telecine identification signal in the telecine conversion information 106 indicates a non-telecine picture, the switch 401 performs switching on a frame-by-frame basis, and samples frames in the input progressive picture signal 101 in a rhythm of 2 frame intervals, so as to output them as the progressive picture signal 103 for which sampling conversion has been performed.

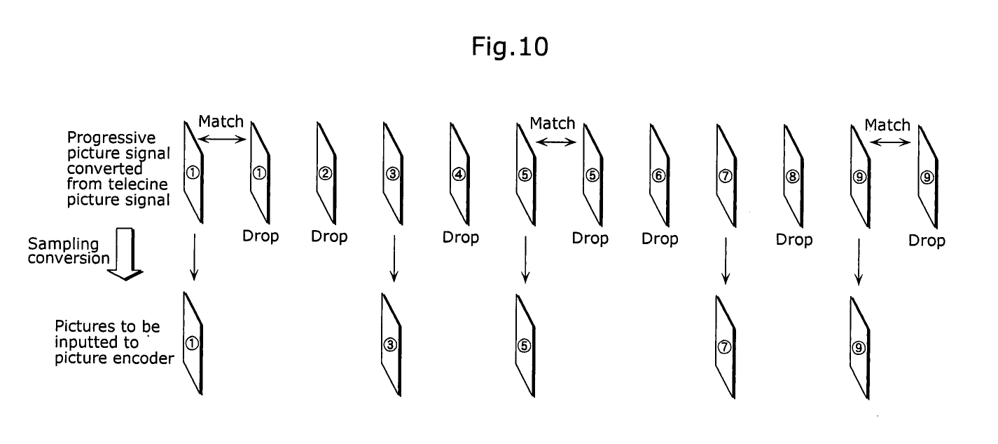

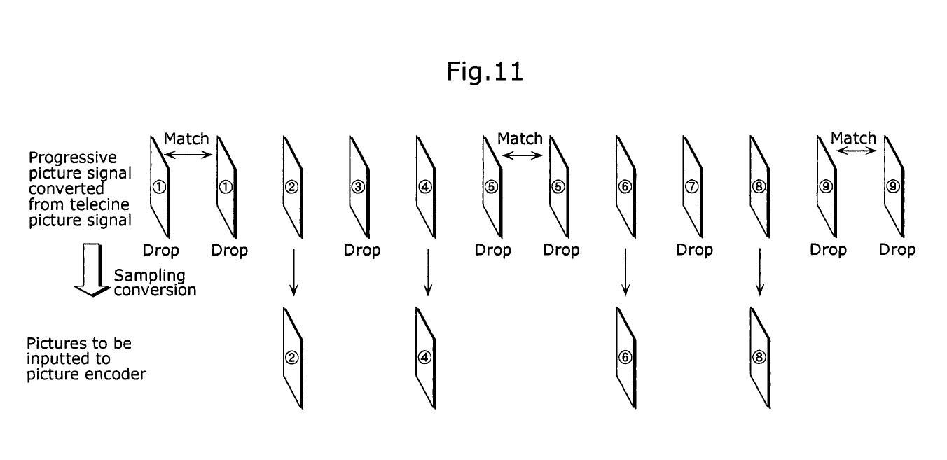

Note that, in the present embodiment, an example shown in FIG. 9 is not an exclusive sampling conversion performed by the sampling converter 102a when a telecine identification signal in the telecine conversion information 106 indicates a telecine picture, and therefore that sampling conversion may be performed according to, for example, two patterns illustrated in FIGS. 10 and 11. In a pattern shown in FIG. 10, when a frame repetition signal in the telecine conversion information 106 indicates “repetition”, the switch 401 samples frames in the progressive picture signal 101 at every 3 frame intervals so as to output 1 frame in the input progressive picture signal 101 (in an example in FIG. 10, this frame is the former of the two frames with the frame number 1 in display order) as a frame in the progressive picture signal 103 for which sampling conversion has been performed, and the next frame (this frame is the latter of the two frames with the frame number 1 in display order) and the next frame (the frame with the frame number 2) are directed to the ground output 402, and the next frame (the frame with the frame number 3) is outputted as a frame in the progressive picture signal 103. After this, the switch 401 samples frames in the progressive picture signal 101 in a rhythm of “2 frame intervals, 3 frame intervals, and 2 frame intervals”, so as to output them as frames in the progressive picture signal 103 for which sampling conversion has been performed. Stated another way, as shown in FIG. 10, frames with the frame numbers 1, 3, 5, 7, and 9 are sampled to be outputted as the progressive picture signal 103 for which sampling conversion has been performed.

In a pattern shown in FIG. 11, when a frame repetition signal in the telecine conversion information 106 indicates “repetition”, the switch 401 samples frames in the input progressive picture signal 101 at every 2 frame intervals so as to output 1 frame in the input progressive picture signal 101 (in an example in FIG. 11, this frame is the latter of the two frames with the frame number 1 in display order) is directed to the ground output 402, and the next frame (the frame with the frame number 2) is outputted as a frame in the progressive picture signal 103, and the next frame (the frame with the frame number 3) is directed to the ground output 402, and the next frame (the frame with the frame number 4) is outputted as a frame in the progressive picture signal 103. After this, the switch 401 samples frames in the progressive picture signal 101 in a rhythm of “3 frame intervals, 2 frame intervals, and 3 frame intervals” so as to output them as frames in the progressive picture signal 103 for which sampling conversion has been performed. Stated another way, as shown in FIG. 11, frames with the frame numbers 2, 4, 6, and 8 are sampled to be outputted as the progressive picture signal 103 for which sampling conversion has been performed.

Note that original pictures in an input progressive picture signal are not necessarily a mixture of a cinema signal and an NTSC signal, and therefore that an input picture signal may be a progressive picture signal converted from original pictures including only either of a cinema signal and an NTSC signal.

Furthermore, the first to the third sampling rates are not limited to the above-given values, and therefore it is also possible to carry out the present embodiment with the first sampling rate being 30 frames/s, the second sampling rate being 12 frames/s, and the third sampling rate being 15 frames/s.

As described above, it is possible for the picture coding apparatus according to the second embodiment to eliminate or minimize unnatural motions, since it is capable of switching a sampling rhythm to an optimum one according to the telecine conversion information 106 provided from outside, even when it codes a progressive picture signal including a mixture of a part which was originally a cinema signal and a part which was originally an NTSC signal. More specifically, the picture coding apparatus according to the second embodiment is capable of coding the part which was originally a cinema signal in a sampling rhythm appropriate to display a cinema signal (more specifically, a sampling rhythm of 2 frame intervals and 3 frame intervals) and capable of coding a part which was originally an NTSC signal in a sampling rhythm appropriate to display a non-telecine material as a progressive picture (more specifically, a sampling rhythm of 2 frame intervals).

Also, since the temporal relationship among frames is not changed before and after sampling conversion, it is possible to minimize unnatural motions, even if the telecine conversion information 106 indicating whether a part was originally a cinema signal or an NTSC signal is incorrect information.

Moreover, in the present embodiment, when the picture encoder 104 performs coding on the progressive picture signal 103 for which sampling conversion has been performed according to MPEG-4, for example, since frame times can be represented by the same VOP time increment resolution, it is possible to simplify processing without needing to make a change in information of the VOP time increment resolution.

(Third Embodiment)

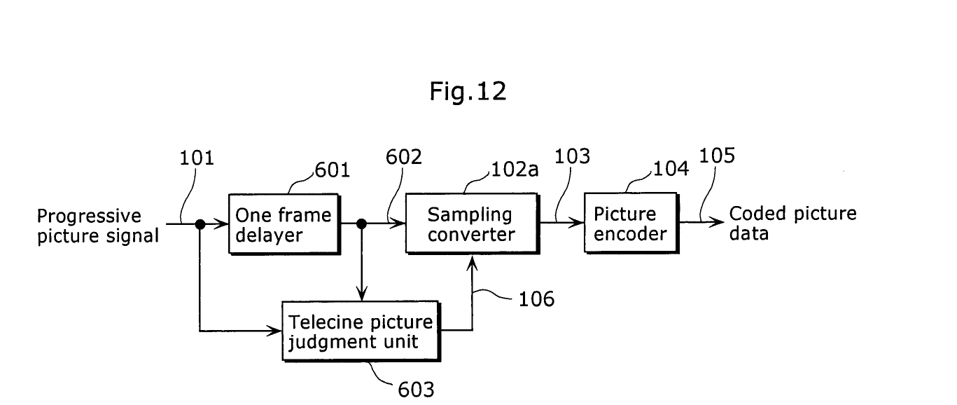

Referring to FIGS. 12˜14, the third embodiment according to the present invention is explained.

The picture coding apparatus according to the third embodiment is embodied by newly adding a telecine picture judgment unit to the picture coding apparatus of either the first or the second embodiment of the present invention, and is capable of detecting the telecine conversion information 106 from an input progressive picture signal including a mixture of a part which was originally a cinema signal and a part which was originally an NTSC signal.

FIG. 12 is a block diagram showing the configuration of the picture coding apparatus according to the third embodiment of the present invention.

The picture coding apparatus according to the third embodiment includes a one frame delayer 601 and a telecine picture judgment unit 603 in addition to the configuration of the picture coding apparatus of either the first or the second embodiment of the present invention, but the other configuration is equivalent to that of the picture coding apparatus according to the first or the second embodiment of the present invention. Therefore, an explanation is given here only of the operations of the one frame delayer 601 and the telecine picture judgment unit 603.

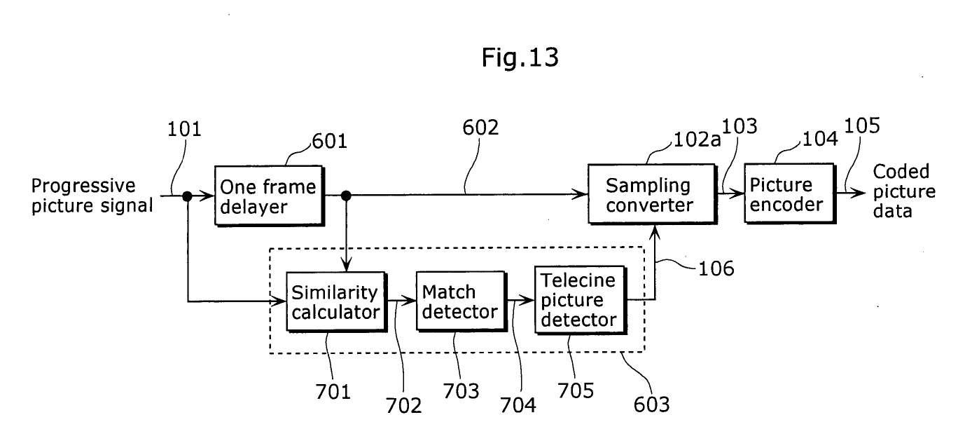

In the picture coding apparatus according to the third embodiment as shown in FIG. 13, the telecine picture judgment unit 603 judges whether an original picture is in a part which was originally a cinema signal or a part which was originally an NTCS signal on the basis of the input progressive picture signal 101 and a progressive picture signal 602 which is generated as a result of delaying the progressive picture signal 101 by the one frame delayer 601 by 1 frame. When judging that the original picture is a telecine picture, the telecine picture judgment unit 603 further judges whether the progressive picture signal 101 and the progressive picture signal 602 resulted from delaying 1 frame match or not, and outputs the judgment result as the telecine conversion information 106. Unlike the picture coding apparatus according to the first or the second embodiment of the present invention, the progressive picture signal 602 resulted from delaying 1 frame is inputted to the sampling converter 102a instead of the progressive picture signal 101.

Referring to FIG. 13, a concrete explanation is given of an example of the telecine picture judgment unit 603 according to the third embodiment.

The telecine picture judgment unit 603 in the picture coding apparatus in FIG. 13 is illustrated with a more concrete example configuration. In FIG. 13, a similarity calculator 701 calculates a degree of similarity 702 between two consecutive frames, based on the input progressive picture signal 101 and the progressive picture signal 602 resulted from delaying 1 frame by the one frame delayer 601. A match detector 703 judges whether such two consecutive frames match (the same frame repeats itself) or not based on the degree of similarity 702, and outputs a match signal 704. A telecine picture detector 705 judges whether a cycle indicated by the match signal 704 in which two consecutive frames match and a cycle indicating that an original picture is a cinema signal (e.g. 5 frames in the case of a 30-frame progressive picture signal) match or not, and judges that the original picture is a cinema signal if the above two cycles match each other. On the other hand, the telecine picture detector 705 judges that the original picture is an NTSC signal if the above two cycles do not match each other. The telecine picture detector 705 outputs the above judgment result and the match signal 704 as the telecine conversion information 106.

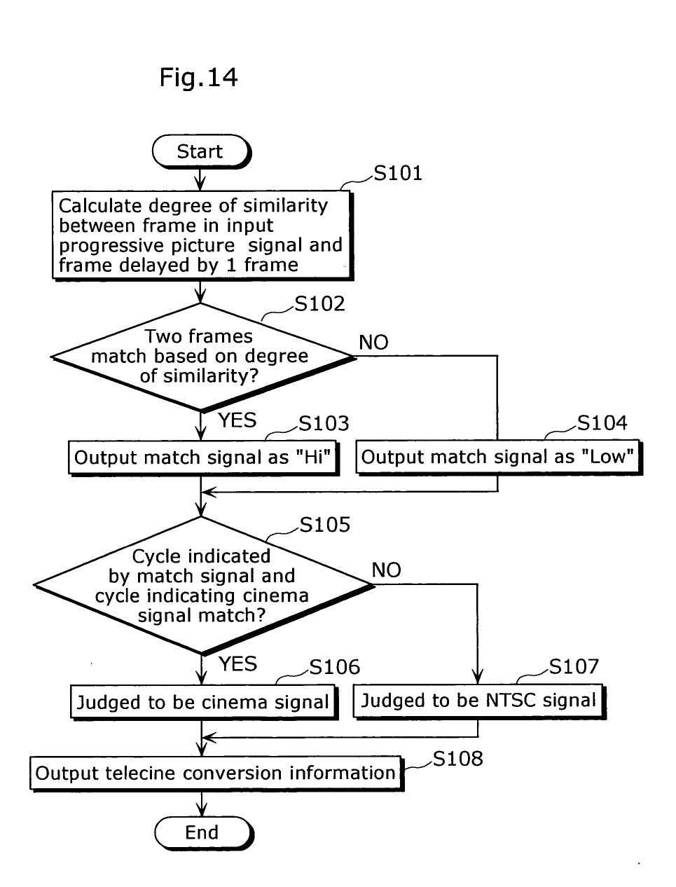

An explanation is given of the operation of the telecine picture judgment unit 603 with the above configuration. FIG. 14 is a flowchart showing the operation of the telecine picture judgment unit 603.

The similarity calculator 701 calculates a degree of similarity 702 between two consecutive frames which are a frame in the input progressive picture signal 101 and a frame in the progressive picture signal 602 which has been delayed by the one frame delayer 601 by 1 frame, and outputs the resultant to the match detector 703 (Step S101). Here, the similarity calculator 701 calculates the degree of similarity between two frames with respect to their pixel values, using a sum of absolute differences, a sum of square differences and a differential distribution, and the like. Next, the match detector 703 judges whether the two consecutive frames match each other (the same frame repeats itself) or not, based on the input degree of similarity 702 (Step S102). Here, the match detector 703 makes a judgment by comparing the size of the degree of similarity 702 and the size of a predetermined threshold value. When the judgment result shows that the two consecutive frames match each other (YES in Step S102), the match detector 703 outputs the match signal 704 as “Hi” (Step S103). When the two consecutive frames does not match (NO in Step S102), on the other hand, the match detector 703 outputs the match signal 704 as “Low” (Step S104).

Next, the telecine picture detector 705 judges whether the following two cycles match or not; a cycle at which “Hi” occurs in the match signal 704 indicating that two frames match and a cycle indicating that an original picture is a cinema signal (e.g. 5 frames in the case of a 30-frame progressive picture signal) (Step S105). When the judgment result shows that these two cycles match (YES in Step S105), the telecine picture detector 705 judges that the input frame is a cinema signal (Step S106). When the above two cycles do not match (NO in Step S105), on the other hand, the telecine picture detector 705 judges that the input frame is an NTSC signal (Step S107). Subsequently, the telecine picture detector 705 outputs the above judgment result and the match signal 704 as the telecine conversion information 106 (Step S108).

Note that original pictures in an input progressive picture signal are not necessarily a mixture of a cinema signal and an NTSC signal, and therefore that an input picture signal may be a progressive picture signal converted from original pictures including only either of a cinema signal and an NTSC signal.

Also note that, in the above explanation, the similarity calculator 701 calculates the degree of similarity between two frames with respect to their pixel values, using a sum of absolute differences, a sum of square differences and a differential distribution, and the like, but it is possible to carry out the present embodiment by the use of other indexes as long as such indexes indicate the degree of similarity between two frames. Moreover, in the above explanation, although the match detector 703 makes a judgment by comparing the size of the degree of similarity 702 and the size of a predetermined threshold value, it is possible to carry out the present embodiment by the use of another method as long as whether two frames match or not can be judged in such method according to the degree of similarity 702.

As described above, it is possible for the picture coding apparatus according to the third embodiment to eliminate or minimize unnatural motions, since it is capable of generating telecine conversion information from an input progressive picture, and capable of performing coding, on the basis only of a progressive picture signal including a mixture of a part which was originally a cinema signal and a part which was originally an NTSC signal, by switching a sampling rate and a sampling rhythm to optimum ones for displaying the part which was originally a cinema signal as a cinema signal and by switching a sampling rate and a sampling rhythm to optimum ones for displaying the part which was originally an NTSC signal as a progressive picture.

(Fourth Embodiment)

If a program for realizing the picture coding method as shown in each of the aforementioned embodiments is recorded on a recording medium such as a flexible disk, it becomes possible to easily perform the processing presented in each of the above embodiments in an independent computer system.

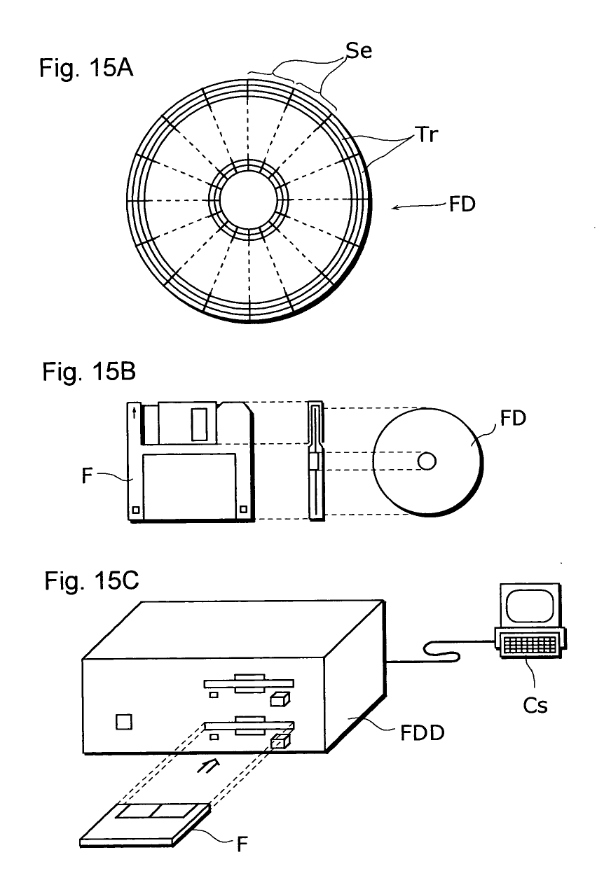

FIG. 15 is a diagram explaining the case where the picture coding method presented in each of the above embodiments is executed by a computer system using a program stored in a recording medium such as a flexible disk.

FIG. 15B shows an external view of a flexible disk viewed from the front, a schematic cross-sectional view and the flexible disk itself, while FIG. 15A illustrates an example physical format of the flexible disk FD as a recording medium itself. The flexible disk FD is contained in a case F, and a plurality of tracks Tr are formed concentrically on the surface of the flexible disk FD in the radius direction from the periphery, each track being divided into 16 sectors Se in the angular direction. Therefore, the above program is recorded in an area allocated for it on the flexible disk FD.

FIG. 15C shows the structure for recording and reading out the program on and from the flexible disk FD. When the program that realizes the picture coding method is recorded on the flexible disk FD, the above program is written by the use of the computer system Cs via a flexible disk drive FDD. Meanwhile, when the picture coding method i s constructed in the computer system Cs through the program on the flexible disk FD, the program is read out from the flexible disk via the flexible disk drive and transferred to the computer system.

The above explanation is given on the assumption that a recording medium is a flexible disk, but an optical disc may also be used. In addition, the recording medium is not limited to this, and any other medium such as an IC card and a ROM cassette capable of recording a program can also be used.

Here, an explanation is further given of applications of the picture coding method as shown in the above embodiments as well as a system using them.

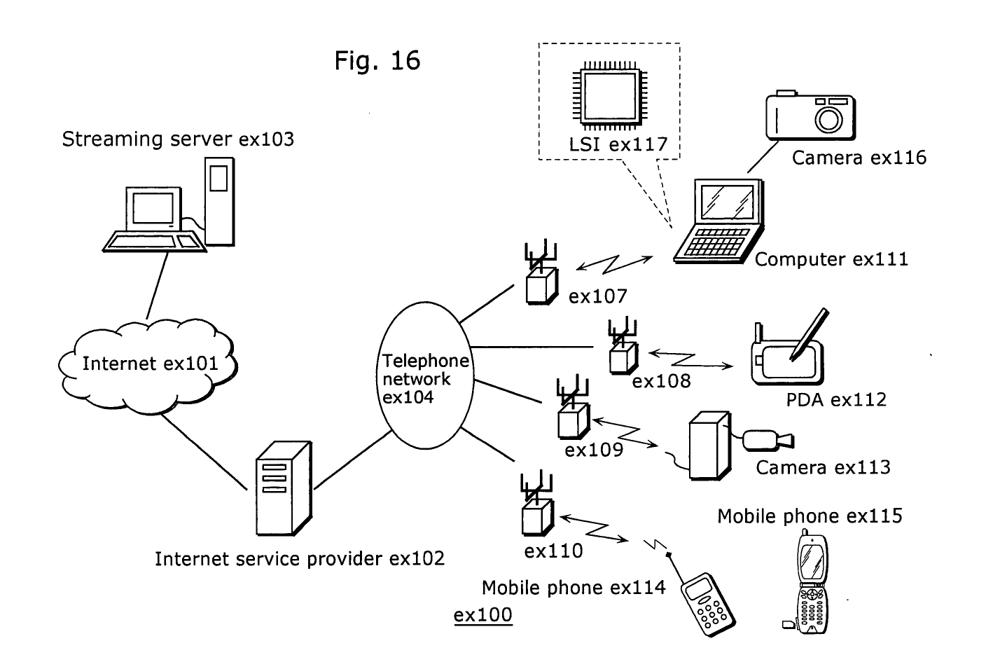

FIG. 16 is a block diagram showing an overall configuration of a content supply system ex100 for realizing a content distribution service. The area for providing a communication service is divided into cells of desired size, and base stations ex107˜ex110, which are fixed wireless stations, are placed in respective cells.

In this content supply system ex100, devices such as a computer ex111, a PDA (Personal Digital Assistant) ex112, a camera ex113, a cellular phone ex114, and a camera-equipped cellular phone ex115 are respectively connected to the Internet ex101 via an Internet service provider ex102, a telephone network ex104, and the base stations ex107˜ex110.

However, the content supply system ex100 is not limited to the combination as shown in FIG. 16, and may be connected to a combination of any of them. Also, each of the devices may be connected directly to the telephone network ex104, not via the base stations ex107˜ex110, which are fixed wireless stations.

The camera ex113 is a device such as a digital video camera capable of shooting moving pictures. The cellular phone may be a cellular phone of a PDC (Personal Digital Communication) system, a CDMA (Code Division Multiple Access) system, a W-CDMA (Wideband-Code Division Multiple Access) system or a GSM (Global System for Mobile Communications) system, a PHS (Personal Handyphone system) or the like, and may be any one of these.

Furthermore, a streaming server ex103 is connected to the camera ex113 via the base station ex109 and the telephone network ex104, which enables live distribution or the like based on coded data transmitted by the user using the camera ex113. Either the camera ex113 or a server and the like capable of data transmission processing may code the shot data. Also, moving picture data shot by a camera ex116 may be transmitted to the streaming server ex103 via the computer ex111. The camera ex116 is a device such as a digital camera capable of shooting still pictures and moving pictures. In this case, either the camera ex116 or the computer ex111 may code the moving picture data. An LSI ex117 included in the computer ex111 or the camera ex116 performs coding processing. Note that software for coding and decoding pictures may be integrated into a certain type of storage medium (such as a CD-ROM, a flexible disk and a hard disk) that is a recording medium readable by the computer ex111 and the like. Furthermore, the camera-equipped cellular phone ex115 may transmit the moving picture data. This moving picture data is data coded by an LSI included in the cellular phone ex115.

In the content supply system ex100, content (e.g. a music live video) which has been shot by the user using the camera ex113, the camera ex116 or the like is coded in the same manner as the above-described embodiments and transmitted to the streaming server ex103, and the streaming server ex103 makes stream distribution of the content data to clients at their request. Here, the clients include the computer ex111, the PDA ex112, the camera ex113, the cellular phone ex114 and so forth capable of decoding the above coded data. The content supply system ex100 with the above structure is a system that enables the clients to receive and reproduce the coded data and realizes personal broadcasting by allowing them to receive, decode and reproduce the data in real time.

The picture coding apparatus presented in the above embodiments can be used for coding and decoding to be performed in each of the devices making up the above system.

An explanation is given of a cellular phone as an example.

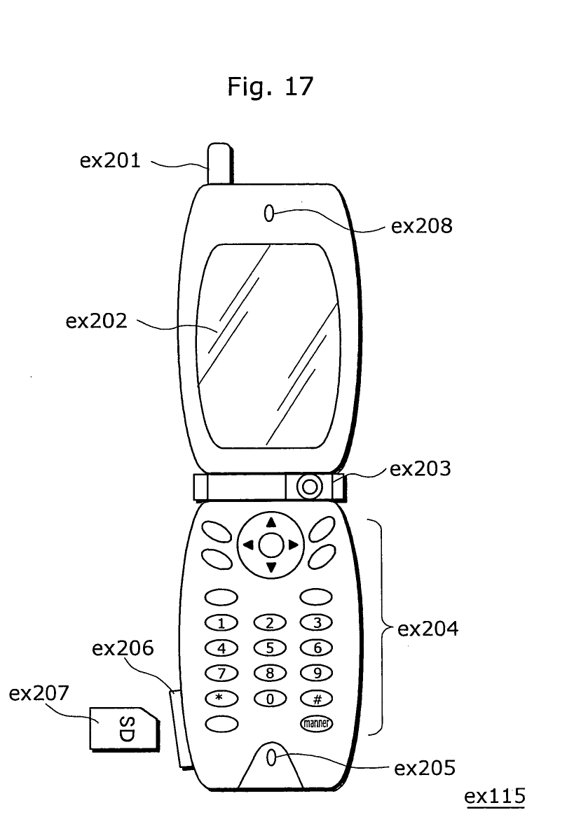

FIG. 17 is a diagram showing an example of the cellular phone ex115 that employs the picture coding method explained in the above embodiments. The cellular phone ex115 has an antenna ex201 for transmitting/receiving radio waves to and from the base station ex110 via radio waves, a camera unit ex203 such as a CCD camera capable of shooting video and still pictures, a display unit ex202 such as a liquid crystal display for displaying the data obtained by decoding video and the like shot by the camera unit ex203 and video and the like received by the antenna ex201, a main body including a set of operation keys ex204, a voice output unit ex208 such as a speaker for outputting voices, a voice input unit ex205 such as a microphone for inputting voices, a recording medium ex207 for storing coded data or decoded data such as data of moving or still pictures shot by the camera, data of received e-mails and moving picture data or still picture data, and a slot unit ex206 for enabling the recording medium ex207 to be attached to the cellular phone ex115. The recording medium ex207 is embodied as a flash memory element, a kind of EEPROM (Electrically Erasable and Programmable Read Only Memory) that is an electrically erasable and rewritable nonvolatile memory, stored in a plastic case such as an SD card.

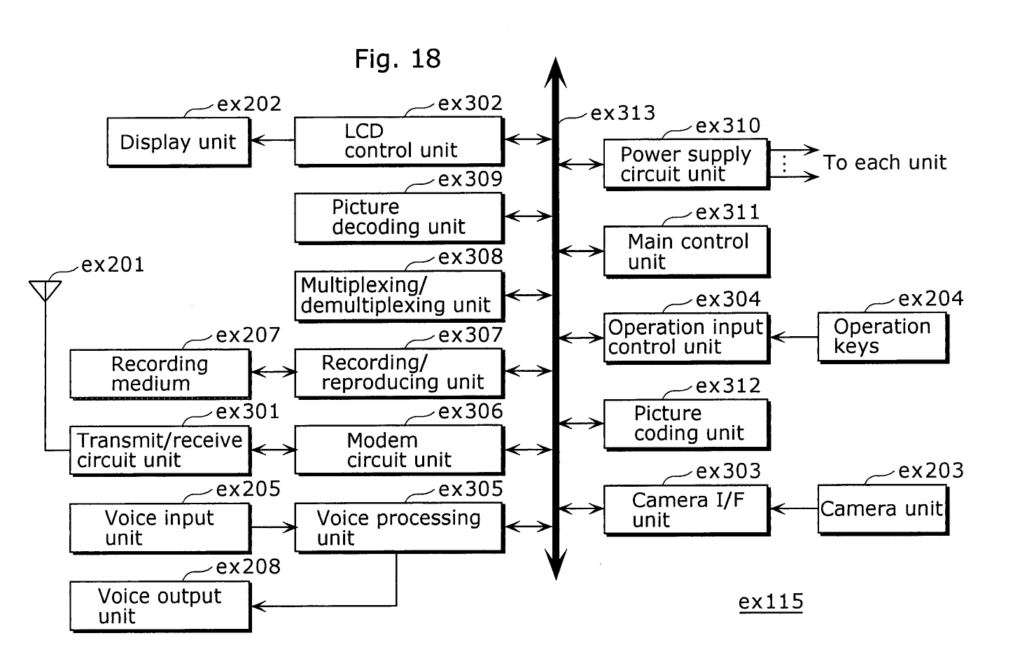

Next, referring to FIG. 18, an explanation is given of the cellular phone ex115. In the cellular phone ex115, a main control unit ex311 for centrally controlling the display unit ex202 and each unit of the main body having the operation keys ex204 is configured in a manner in which a power supply circuit unit ex310, an operation input control unit ex304, a picture coding unit ex312, a camera interface unit ex303, an LCD (Liquid Crystal Display) control unit ex302, a picture decoding unit ex309, a multiplexing/demultiplexing unit ex308, a recording/reproducing unit ex307, a modem circuit unit ex306, and a voice processing unit ex305 are interconnected via a synchronous bus ex313.

When a call-end key or a power key is turned ON by a user's operation, the power supply circuit unit ex310 supplies each unit with power from a battery pack, so as to activate the camera-equipped digital cellular phone ex115 to make it into a ready state.

In the cellular phone ex115, the voice processing unit ex305 converts a voice signal received by the voice input unit ex205 in conversation mode into digital voice data under the control of the main control unit ex311 comprised of a CPU, a ROM, a RAM and others, the modem circuit unit ex306 performs spread spectrum processing on it, and a transmit/receive circuit unit ex301 performs digital-to-analog conversion processing and frequency transform processing on the data, so as to transmit the resultant via the antenna ex201. Also, in the cellular phone ex115, a received signal received by the antenna ex201 in conversation mode is amplified and performed of frequency transform processing and analog-to-digital conversion processing, the modem circuit unit ex306 performs inverse spread spectrum processing on the resultant, and the voice processing unit ex305 converts it into an analog voice signal, so as to output it via the voice output unit ex208.

Furthermore, when sending an e-mail in data communication mode, text data of the e-mail inputted by operating the operation keys ex204 on the main body is sent out to the main control unit ex311 via the operation input control unit ex304. In the main control unit ex311, after the modem circuit unit ex306 performs spread spectrum processing on the text data and the transmit/receive circuit unit ex301 performs digital-to-analog conversion processing and frequency transform processing on it, the resultant is transmitted to the base station ex110 via the antenna ex2O1.

When picture data is transmitted in data communication mode, the picture data shot by the camera unit ex203 is supplied to the picture coding unit ex312 via the camera interface unit ex303. When picture data is not to be transmitted, it is also possible to display such picture data shot by the camera unit ex203 directly on the display unit ex202 via the camera interface unit ex303 and the LCD control unit ex302.

The picture coding unit ex312, which includes the picture coding apparatus according to the present invention in its configuration, performs compression coding on the picture data supplied from the camera unit ex203 using the coding method used by the picture coding apparatus presented in the above-mentioned embodiments, so as to convert it into coded picture data, and sends it out to the multiplexing/demultiplexing unit ex308. At this time, the cellular phone ex115 sends voices received by the voice input unit ex205 while the shooting by the camera unit ex203 is taking place, to the multiplexing/demultiplexing unit ex308 as digital voice data via the voice processing unit ex305.

The multiplexing/demultiplexing unit ex308 multiplexes the coded picture data supplied from the picture coding unit ex312 and the voice data supplied from the voice processing unit ex305 using a predetermined method, the modem circuit unit ex306 performs spread spectrum processing on the resulting multiplexed data, and the transmit/receive circuit unit ex301 performs digital-to-analog conversion processing and frequency transform processing on the resultant, so as to transmit the processed data via the antenna ex201.

When receiving, in data communication mode, data included in a moving picture file which is linked to a Web page or the like, the modem circuit unit ex306 performs inverse spread spectrum processing on the received signal received from the base station ex110 via the antenna ex201, and sends out the resulting multiplexed data to the multiplexing/demultiplexing unit ex308.

In order to decode the multiplexed data received via the antenna ex201, the multiplexing/demultiplexing unit ex308 separates the multiplexed data into a coded bit stream of picture data and a coded bit stream of voice data, and supplies such coded picture data to the picture decoding unit ex309 and such voice data to the voice processing unit ex305 via the synchronous bus ex313.

Next, the picture decoding unit ex309 decodes the coded bit stream of the picture data using a decoding method paired with the coding method as shown in the above-mentioned embodiments so as to generate moving picture data for reproduction, and supplies such data to the display unit ex202 via the LCD control unit ex302. Accordingly, moving picture data included in the moving picture file linked to a Web page, for instance, is displayed. At the same time, the voice processing unit ex305 converts the voice data into an analog voice signal, and then supplies this signal to the voice output unit ex208. Accordingly, voice data included in the moving picture file linked to a Web page, for instance, is reproduced.

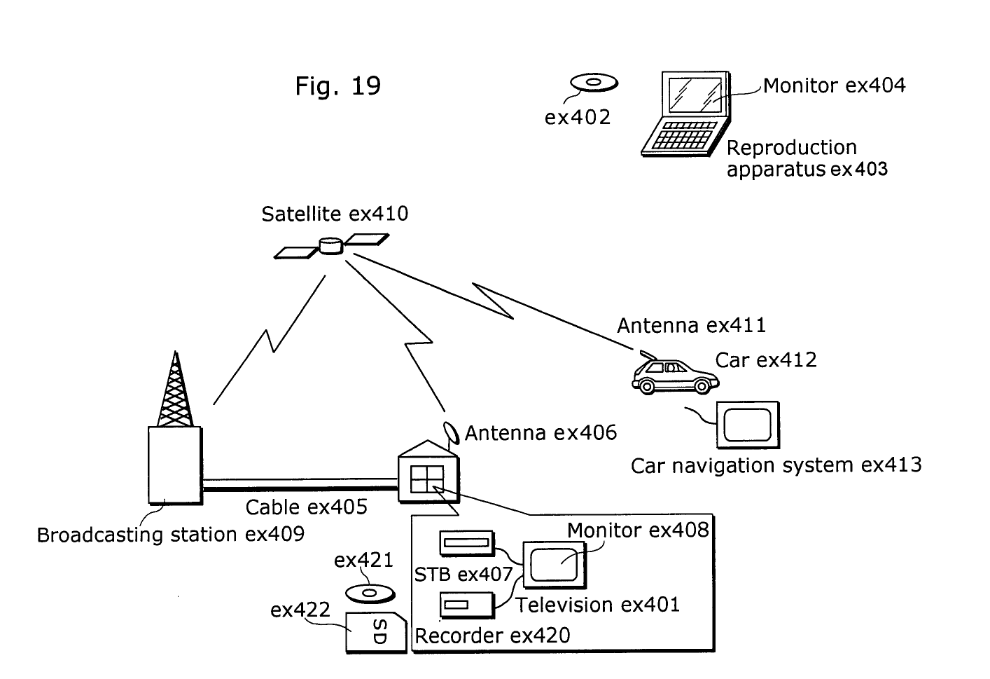

Note that the aforementioned system is not an exclusive example and therefore that the picture coding apparatus of the above embodiments can be incorporated into a digital broadcasting system as shown in FIG. 19, against the backdrop that satellite/terrestrial digital broadcasting has been a recent topic of conversation. To be more specific, at a broadcasting station ex409, a coded bit stream of video information is transmitted, by radio waves, to a satellite ex410 for communications or broadcasting. Upon receipt of it, the broadcast satellite ex410 transmits radio waves for broadcasting, an antenna ex406 of a house equipped with satellite broadcasting reception facilities receives such radio waves, and an apparatus such as a television (receiver) ex401 and a set top box (STP) ex407 decodes the coded bit stream and reproduces the decoded data. A picture decoding apparatus can be implemented in the reproduction apparatus ex403 for reading and decoding the coded bit stream recorded on a storage medium ex402 that is a recording medium such as a CD and a DVD. In this case, a reproduced video signal is displayed on a monitor ex404. It is also conceived that the picture decoding apparatus is implemented in the set top box ex407 connected to a cable ex405 for cable television or the antenna ex406 for satellite/ground-based broadcasting so as to reproduce it on a television monitor ex408. In this case, the picture decoding apparatus may be incorporated into the television, not in the set top box. Or, a car ex412 with an antenna ex411 can receive a signal from the satellite ex410, the base station ex107 or the like, so as to reproduce a moving picture on a display device such as a car navigation system ex413 mounted on the car ex412.

Furthermore, it is also possible to code a picture signal by the moving picture coding apparatus presented in the above embodiments and to record the resultant in a recording medium. Examples include a DVD recorder for recording a picture signal on a DVD disc ex421 and a recorder ex420 such as a disc recorder for recording a picture signal on a hard disk. Moreover, a picture signal can be recorded in an SD card ex422. If the recorder ex420 is equipped with a moving picture decoding apparatus, it is possible to reproduce a picture signal recorded on the DVD disc ex421 or in the SD card ex422, and display it on the monitor ex408.

As the configuration of the car navigation system ex413, the configuration without the camera unit ex203 and the camera interface unit ex303, out of the configuration shown in FIG. 19, is conceivable. The same is applicable to the computer ex111, the television ex401 (receiver) and the like.

Concerning the terminals such as the cellular phone ex114, a transmitting/receiving terminal having both an encoder and a decoder, as well as a transmitting terminal only with an encoder and a receiving terminal only with a decoder are possible as forms of implementation.

As stated above, it is possible to employ the picture coding method presented in the above embodiments into any one of the above-described devices and systems. Accordingly, it becomes possible to achieve an effect explained in the aforementioned embodiments.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

### Industrial Applicability

As explained above, the picture coding method according to the present invention is suitable as a method to be employed by a cellular phone, a DVD apparatus and a personal computer, and the like for coding a progressive picture signal including at least either a part which was originally a cinema signal or a part which was originally an NTSC signal.

What is claimed is:

1. A picture coding method for coding a progressive picture signal including at least either a cinema signal part which was originally a cinema signal or an NTSC signal part which was originally an NTSC signal for television broadcasting, the picture coding method comprising:
a sampling step of sampling frames from frames in the cinema signal part in the progressive picture signal using a first method and frames from frames in the NTSC signal part in the progressive picture signal using a second method; and
a coding step of coding the frames which are sampled in the sampling step.

2. The picture coding method according to claim 1,
wherein, in the sampling step, the sampling is performed using either the first method or the second method, depending on telecine conversion information indicating whether the progressive picture signal was originally a cinema signal or an NTSC signal.

3. The picture coding method according to claim 1,
wherein the cinema signal part in the progressive picture signal is a signal that includes two identical consecutive frames for every predetermined number of frames, the signal being a progressive picture signal converted from an NTSC signal which has been converted from the cinema signal, and
in the first method, one of said two frames is eliminated, and the sampling is performed at equal intervals.

4. The picture coding method according to claim 3,
wherein, in the first method, the sampling is performed at equal intervals in which the number of frames per second is a divisor of 24.

5. The picture coding method according to claim 1,
wherein the cinema signal part in the progressive picture signal is a signal that includes two identical consecutive frames for every predetermined number of frames, the signal being a progressive picture signal converted from an NTSC signal which has been converted from the cinema signal, and
in the first method, the sampling is performed in a manner in which frame intervals become predetermined unequal intervals with respect to said two identical consecutive frames.

6. The picture coding method according to claim 5,
wherein, in the first method, the sampling is performed in the following manner with respect to the latter of the two frames in display order: sampling is first performed at a rate of one frame for every two frames, and then at a rate of one frame for every three frames, after which sampling is repeatedly performed at these rates.

7. The picture coding method according to claim 5,
wherein, in the first method, the sampling is performed in the following manner with respect to the former of the two frames in display order: sampling is first performed at a rate of one frame for every three frames, and then at a rate of one frame for every two frames, after which sampling is repeatedly performed at these rates.

8. The picture coding method according to claim 5,
wherein, in the first method, the sampling is performed in the following manner with respect to a subsequent frame of the two frames in display order: sampling is first performed at a rate of one frame for every two frames, and then at a rate of one frame for every three frames, after which sampling is repeatedly performed at these rates.

9. The picture coding method according to claim 1, further comprising an original picture judgment step of judging whether each frame in the progressive picture signal was originally a cinema signal or an NTSC signal, based on said progressive picture signal.

10. The picture coding method according to claim 9,
wherein the cinema signal part in the progressive picture signal is a signal that includes two identical consecutive frames for every predetermined number of frames, the signal being a progressive picture signal converted from an NTSC signal which has been converted from the cinema signal, and
the original picture judgment step includes:
a delay step of delaying a frame in the progressive picture signal by one frame;
a similarity calculation step of calculating a degree of similarity between a frame in the input progressive picture signal and the frame which has been delayed by one frame in the delay step;
a match judgment step of judging whether the two consecutive frames match or not based on the degree of similarity calculated in the similarity calculation step, and outputting a match signal when said two consecutive frames are judged to match each other; and
a cycle judgment step of judging whether said each frame in the progressive picture signal was originally a cinema signal or an NTSC signal, based on a cycle indicated by the match signal outputted in the match judgment step.

11. A picture coding apparatus for coding a progressive picture signal including at least either a cinema signal part which was originally a cinema signal or an NTSC signal part which was originally an NTSC signal for television broadcasting, the picture coding apparatus comprising:
a sampling conversion unit operable to sample the input progressive picture signal using a different sampling conversion method depending on telecine conversion information indicating whether the progressive picture signal was originally a cinema signal or an NTSC signal, and output the sampled progressive picture signal; and
a picture coding unit operable to code said progressive picture signal outputted by the sampling conversion unit.

12. A program for coding a progressive picture signal including at least either a cinema signal part which was originally a cinema signal or an NTSC signal part which was originally an NTSC signal for television broadcasting, the program causing a computer to execute the following steps:
a sampling step of sampling frames from frames in the cinema signal part in the progressive picture signal using a first method and frames from frames in the NTSC signal part in the progressive picture signal using a second method; and
a coding step of coding the frames which are sampled in the sampling step.

13. A computer-readable recording medium which stores coded picture data which has been generated by coding a progressive picture signal including a cinema signal part which was originally a cinema signal,
wherein, in the cinema signal part in the coded picture data, frames in the progressive picture signal were sampled at predetermined unequal intervals.
